(19) United States
(12) Patent Application Publication
(10) Pub. No.: US 2011/0310320 A1
(43) Pub. Date: Dec. 22, 2011

(54) LENS ARRAY ELEMENT AND IMAGE DISPLAY DEVICE

(75) Inventors: Kenichi Takahashi, Kanagawa (JP); Yoshihisa Sato, Saitama (JP); Sho Sakamoto, Tokyo (JP)

(73) Assignee: Sony Corporation, Tokyo (JP)

(21) Appl. No.: 13/157,662

(22) Filed: Jun. 10, 2011

(30) Foreign Application Priority Data
Jun. 17, 2010 (JP) 2010-138520

(51) Int. Cl. G02F 1/133

(52) U.S. Cl. 349/33; 349/200

(57) ABSTRACT

Disclosed herein is a lens array element, including: first and second substrates; a first electrode group; a first switch group; a second electrode group; a second switch group; and a liquid crystal layer, wherein the lens effect of an arbitrary area of the liquid crystal layer changes with change in the statuses of the first and second switch groups.

### BACKGROUND OF THE INVENTION

1. Field of the Invention

The present invention relates to a lens array element and image display device, and, more particularly, to a lens array element and image display device designed to electrically control the production of a lens effect so as to achieve three-dimensional display.

2. Description of the Related Art

Existing methods used to achieve stereoscopic viewing show parallax images to produce a parallax or disparity between the left and right eyes of the viewer. Some of these methods require that the viewer should wear goggles adapted to achieve stereoscopic viewing, and others do not.

Those methods requiring the goggles are applied, for example, to movie screening equipment at movie theaters and television receivers. Other methods not requiring the goggles are likely applied, for example, to not only television sets but also displays of portable electronic equipment such as mobile phones, smart phones and netbook computers.

Among the specific methods not requiring the goggles is that which uses an optical device for three-dimensional display on the screen of a liquid crystal display or other two-dimensional display device. The optical device deflects display image light from the two-dimensional display device in a plurality of viewing angle directions.

A lens array having a plurality of cylindrical lenses arranged in parallel is known as an optical device for three-dimensional display. In the case of binocular stereoscopic viewing, for example, different parallax images are shown to the left and right eyes, thus allowing for the viewer to perceive a three-dimensional effect. In order to achieve this, therefore, the plurality of vertically extending cylindrical lenses are horizontally arranged in parallel relative to the display screen of the two-dimensional display device so that the display image light from the two-dimensional display device is horizontally deflected, thus allowing for the left and right parallax images to reach the left and right eyes of the viewer properly.

In addition to cylindrical lenses, a switching lens array element using liquid crystal lenses (hereinafter referred to as a liquid crystal lens array element) is known (refer, for example, to Japanese Patent Laid-Open No. 2008-9370).

A liquid crystal lens array element can be electrically switched to the presence or absence of a lens effect comparable to that produced by the cylindrical lenses. Therefore, a two-dimensional display device can be switched to one of two display modes, i.e., two-dimensional display mode in which there is no lens effect and three-dimensional display mode in which a lens effect is produced, by providing a liquid crystal lens array element on the screen of the two-dimensional display device.

### SUMMARY OF THE INVENTION

As described above, three-dimensional display using a liquid crystal lens array element is likely applied to portable electronic equipment such as smart phones. In this case, it is convenient if it is possible to switch not only the entire screen but also only an arbitrary area of the screen to two-dimensional or three-dimensional display mode.

In general, the resolution is lower in three-dimensional display than in two-dimensional display. Therefore, a possible approach would be to display the portion of the image requiring high resolution in two-dimensional display mode and the rest of the image in three-dimensional display mode. Another approach would be to set, to two-dimensional display mode, the display area adapted to display image material including that which need not be displayed in three-dimensional display mode. For example, when a movie with subtitles is displayed three-dimensionally, the subtitles may be displayed two-dimensionally.

The present invention has been made in light of the foregoing, and it is an aim of the present invention to allow for an arbitrary area of the screen to be set to three-dimensional display mode and the rest of the screen to be set to two-dimensional display mode.

A lens array element according to a first mode of the present invention includes: first and second substrates, a first electrode group, a first switch group, a second electrode group, a second switch group and a liquid crystal layer. The first and second substrates are arranged to be opposed to each other with a gap therebetween. The first electrode group is formed on the side of the first substrate opposed to the second substrate and includes a plurality of electrodes that extend in a first direction and that are arranged in parallel in the direction along the width thereof. The first switch group connects a first voltage generation section and the electrodes of the first electrode group. The first voltage generation section applies voltage to the first electrode group. The second electrode group is formed on the side of the second substrate opposed to the first substrate and includes a plurality of electrodes that extend in a second direction different from the first direction and that are arranged in parallel in the direction along the width thereof. The second switch group connects a second voltage generation section and the electrodes of the second electrode group. The second voltage generation section applies voltage to the second electrode group. The liquid crystal layer is provided between the first and second substrates, includes liquid crystal molecules having refractive index anisotropy and produces a lens effect as a result of change in the direction of alignment of the liquid crystal molecules according to the voltages applied to the first and second electrode groups. The lens effect of an arbitrary area of the liquid crystal layer changes with change in the statuses of the first and second switch groups.

By changing the statuses of the first and second switch groups, it is possible to electrically switch the arbitrary area of the liquid crystal layer to one of two states, one in which there is no lens effect and another in which a lens effect is produced as in the form of cylindrical lenses extending in the first direction, according to the conditions of the voltages applied to the first and second electrode groups.

A lens-effect-free state is assumed when the plurality of electrodes making up the first electrode group and those making up the second electrode group are at the same potential. A lens effect can be produced by selectively applying a drive voltage to the electrodes at the position corresponding to the pitch of the cylindrical lenses of all the electrodes making up the first electrode group and by selectively applying a drive voltage to the electrodes at the position corresponding to the pitch of the cylindrical lenses of all the electrodes making up the second electrode group.

The first electrode group includes a plurality of first electrodes each having a first width that extend in the first direction and that are arranged in parallel. The second electrode group includes a plurality of second electrodes each having a second width smaller than the first width that extend in the second direction and that are arranged in parallel.

The first and second voltage generation sections can apply rectangular wave voltages that are 180 degrees out of phase with each other.

The first and second voltage generation sections can apply rectangular wave voltages having the same voltage amplitude.

A lens array element according to the mode of the present invention includes: first and second substrates, a first electrode group, a first switch group, a plurality of second electrode groups, a second switch group, and a liquid crystal layer. The first and second substrates are arranged to be opposed to each other with a gap therebetween. The first electrode group is formed on the side of the first substrate opposed to the second substrate and extending in a first direction. The first switch group is operable to connect a first voltage generation section and the first electrode group. The plurality of second electrode groups are formed on the side of the second substrate opposed to the first substrate and extending in a second direction different from the first direction. The second switch group is operable to connect a second voltage generation section and the second electrode groups. The liquid crystal layer is provided between the first and second substrates. The lens effect of an arbitrary area of the liquid crystal layer changes with change in the statuses of the first and second switch groups.

The first and second voltage generation sections can apply rectangular wave voltages that are out of phase with each other.

The first and second voltage generation sections can apply rectangular wave voltages having the same voltage amplitude.

In the lens array element according to the first mode of the present invention, the lens effect of an arbitrary area of the liquid crystal layer changes with change in the statuses of the first and second switch groups.

A display device according to a second mode of the present invention includes: a display section, a lens array element, determination means and switch control means. The display section displays an image. The lens array element is provided to be opposed to the display surface of the display section and selectively changes the passage of light beams from the display section. The determination means determines the position of a three-dimensional display area provided on the screen. The switch control means controls switches. The lens array element includes first and second substrates, a first electrode group, a first switch group, a second electrode group, a second switch group and a liquid crystal layer. The first and second substrates are arranged to be opposed to each other with a gap therebetween. The first electrode group is formed on the side of the first substrate opposed to the second substrate and includes a plurality of electrodes that extend in a first direction and that are arranged in parallel in the direction along the width thereof. The first switch group connects a first voltage generation section and the electrodes of the first electrode group. The first voltage generation section applies voltage to the first electrode group. The second electrode group is formed on the side of the second substrate opposed to the first substrate and includes a plurality of electrodes that extend in a second direction different from the first direction and that are arranged in parallel in the direction along the width thereof. The second switch group connects a second voltage generation section and the electrodes of the second electrode group. The second voltage generation section applies voltage to the second electrode group. The liquid crystal layer is provided between the first and second substrates, includes liquid crystal molecules having refractive index anisotropy and produces a lens effect as a result of change in the direction of alignment of the liquid crystal molecules according to the voltages applied to the first and second electrode groups. The switch control means changes the statuses of the first and second switch groups based on the determined position of the three-dimensional display area, thus changing the lens effect of an arbitrary area of the liquid crystal layer.

An image display device according to the mode of the present invention includes: a display section, a lens array element, determination means, and switch control means. The determination means is operable to determine the position of a three-dimensional display area. The switch control means is operable to control switches. The lens array element includes first and second substrates, a first electrode group, a first switch group, a plurality of second electrode groups, a second switch group, and a liquid crystal layer. The first and second substrates are arranged to be opposed to each other with a gap therebetween. The first electrode group is formed on the side of the first substrate opposed to the second substrate and extending in a first direction. The first switch group is operable to connect a first voltage generation section and the first electrode group. The plurality of second electrode groups are formed on the side of the second substrate opposed to the first substrate and extending in a second direction different from the first direction. The second switch group is operable to connect a second voltage generation section and the second electrode groups. The liquid crystal layer is provided between the first and second substrates. The switch control means changes the statuses of the first and second switch groups based on the determined position of the three-dimensional display area.

In the display device according to the second mode of the present invention, the switch control means changes the statuses of the first and second switch groups based on the determined position of the three-dimensional display area, thus changing the lens effect of an arbitrary area of the liquid crystal layer.

The first mode of the present invention provides a lens effect in such a manner as to allow for an arbitrary area of the screen to be set to three-dimensional display mode and the rest of the screen to be set to two-dimensional display mode.

The second mode of the present invention allows for an arbitrary area of the screen to be set to three-dimensional display mode and the rest of the screen to be set to two-dimensional display mode.

### BRIEF DESCRIPTION OF THE DRAWINGS

FIGS. 1A and 1B are appearance diagrams of an electronic device to which an embodiment of the present invention is applied;

FIG. 2 is a sectional view illustrating a configuration example of a liquid crystal lens array element;

FIG. 3 is a sectional view illustrating a first electrode group of the liquid crystal lens array element;

FIG. 4 is a perspective view illustrating first and second electrode groups of the liquid crystal lens array element;

FIG. 5 is a block diagram illustrating a configuration example adapted to control the liquid crystal lens array element;

FIGS. 6A and 6B are diagrams illustrating the statuses of the switches when the entire screen is set to two-dimensional display mode;

FIGS. 7A and 7B are diagrams illustrating the statuses of the switches when only an arbitrary area of the screen is set to three-dimensional display mode;

FIG. 8 is a diagram summarizing association between how the display is used and switch status control;

FIG. 9 is a diagram illustrating the waveforms of voltages generated by X and Y line generation sections;

FIG. 10 is a diagram illustrating an example of a display panel;

FIGS. 11A and 11B are diagrams illustrating the angle formed between the first and second electrode groups according to first to third examples;

FIG. 12 is a diagram illustrating parameter values in the first to third examples;

FIG. 13 is a diagram describing an evaluation method of three-dimensional display; and

FIG. 14 is a diagram illustrating the evaluation of the first to third examples.

### DETAILED DESCRIPTION OF THE PREFERRED EMBODIMENT

A detailed description will be given below of the best mode for carrying out the invention (hereinafter referred to as an embodiment) with reference to the accompanying drawings.

### 1. Embodiment

### [Configuration Example of Electronic Device]

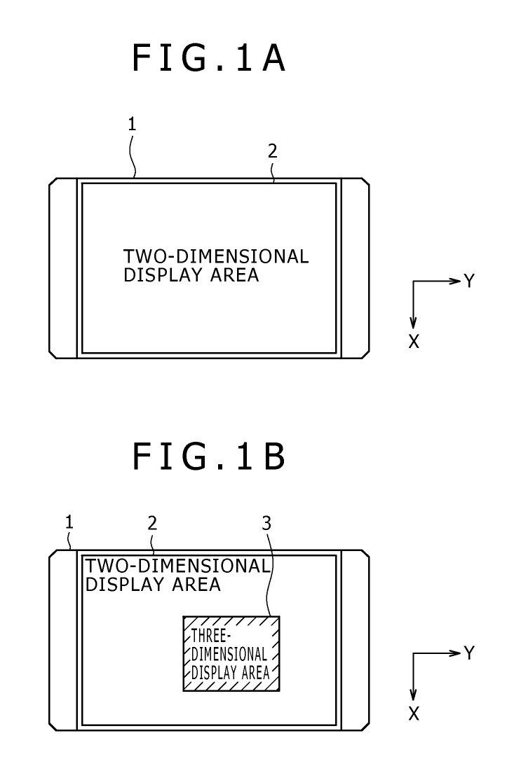

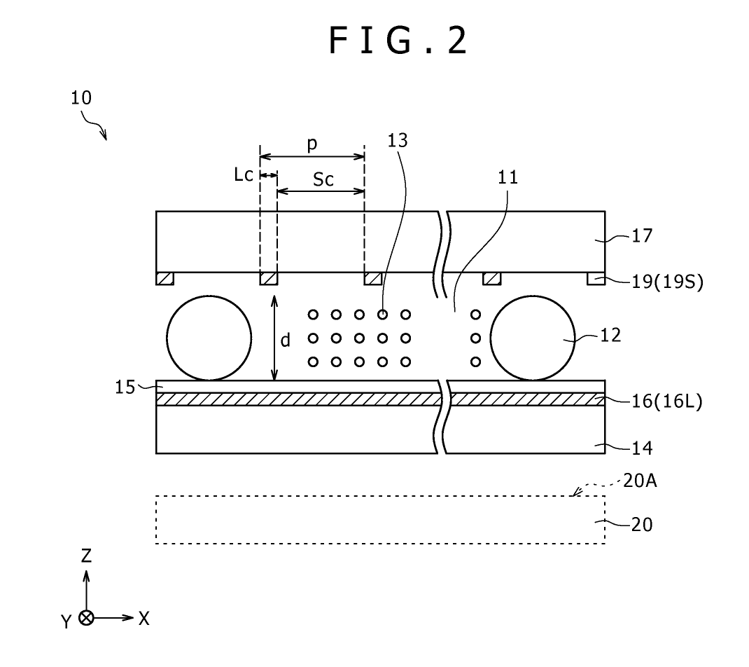

FIGS. 1A and 1B illustrate the appearance of an electronic device which is the embodiment of the present invention. This electronic device 1 has a display 2. The display 2 includes a display panel 20 and liquid crystal lens array element 10 (both shown in FIG. 2). The display panel 20 is a two-dimensional display device. The liquid crystal lens array element 10 is provided on the screen of the display panel 20.

As illustrated in FIG. 1A, the entire screen of the electronic device 1 can be used in two-dimensional display mode. Further, the entire screen can be used in three-dimensional display mode. Still further, as illustrated in FIG. 1B, an arbitrary area of the screen can be used in three-dimensional display mode, and the rest of the screen in two-dimensional display mode.

The area to be used in three-dimensional display mode (hereinafter referred to as a three-dimensional display area) can be specified by the user. More specifically, a rectangle having a diagonal line connecting two points on the screen, for example, can be specified as a three-dimensional display area. Alternatively, a three-dimensional display area can be specified by moving the cursor while dragging it.

### [Configuration Example of the Liquid Crystal Lens Array Element 10]

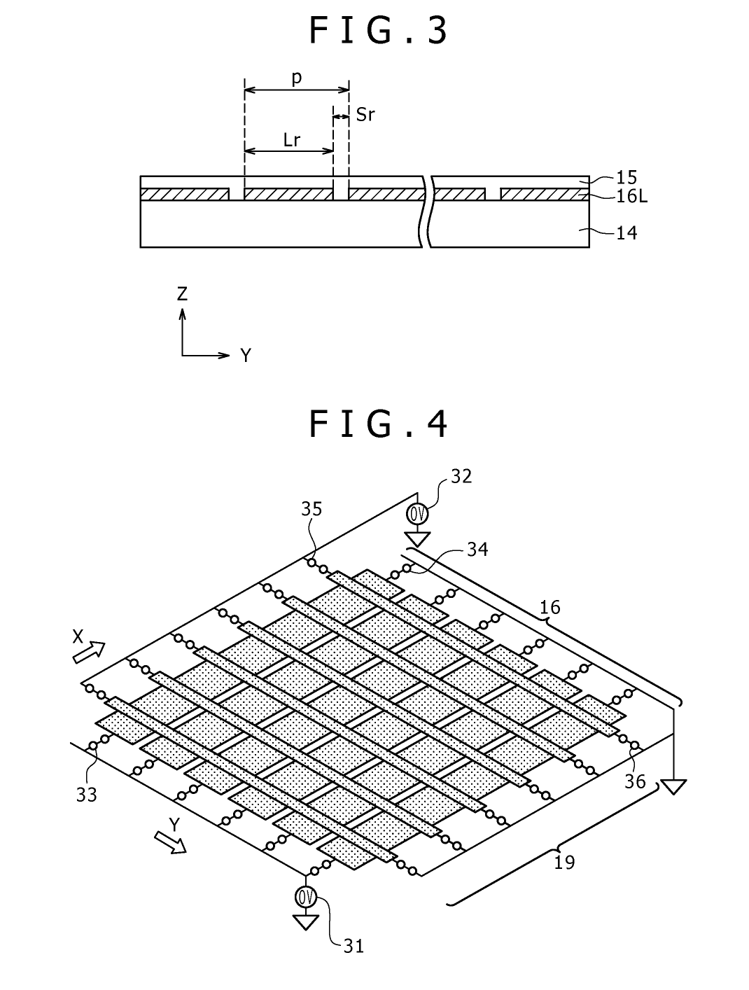

FIGS. 2 and 3 illustrate sectional views of the liquid crystal lens array element 10 making up the display 2. It should be noted that FIG. 2 is a sectional view along the XZ plane, and FIG. 3 is a sectional view along the YZ plane. However, FIG. 3 illustrates only the components provided on a first substrate 14 of the same element 10.

As illustrated in FIG. 2, the liquid crystal lens array element 10 is provided on a display surface 20A of the display panel 20.

The liquid crystal lens array element 10 controls the lens effect according to the display mode selected (two-dimensional or three-dimensional display mode), thus selectively changing the passage of light beams from the display panel 20. The same panel 20 can include, for example, a liquid crystal display or organic EL display. The display panel 20 displays an image based on two-dimensional image data in the area set to two-dimensional display mode and an image based on three-dimensional image data in the area set to three-dimensional display mode. It should be noted that the term “three-dimensional image data” refers, for example, to data including a plurality of parallax images for a plurality of viewing angle directions in three-dimensional display. In the case of binocular three-dimensional display, the term “three-dimensional image data” refers to parallax image data for the right and left eyes.

The liquid crystal lens array element 10 includes first and second substrates 14 and 17 and a liquid crystal layer 11. The first and second substrates 14 and 17 are arranged to be opposed to each other with a gap d therebetween. The liquid crystal layer 11 is provided between the first and second substrates 14 and 17.

The first and second substrates 14 and 17 are transparent substrates made, for example, of a glass or resin material. A first electrode group 16 is formed on the side of the first substrate 14 opposed to the second substrate 17. The first electrode group 16 includes a plurality of transparent electrodes that extend in a first direction (X axis direction in FIG. 2) and that are arranged in parallel in the direction along the width thereof (Y axis direction in FIG. 2) with a gap between every two electrodes. An orientation film 15 is formed above the first substrate 14 with the first electrode group 16 sandwiched therebetween.

Similarly, a second electrode group 19 is formed on the side of the second substrate 17 opposed to the first substrate 14. The second electrode group 19 includes a plurality of transparent electrodes that extend in a second direction (Y axis direction in FIG. 2) different from the first direction and that are arranged in parallel in the direction along the width thereof (X axis direction in FIG. 2) with a gap between every two electrodes. An orientation film 18 is formed above the second substrate 17 with the second electrode group 19 sandwiched therebetween.

The liquid crystal layer 11 includes liquid crystal molecules 13. The alignment direction of the liquid crystal molecules 13 changes according to the voltages applied to the first and second electrode groups 16 and 19, thus allowing for the lens effect to be controlled. The liquid crystal layer 11 can electrically switch, on an area-by-area basis, the liquid crystal lens array element 10 to one of two states, one in which there is no lens effect and another in which there is a lens effect, according to the conditions of the voltages applied to the first and second electrode groups 16 and 19.

The liquid crystal molecules 13 have refractive index anisotropy and are in the form of a refractive index ellipsoid having different refractive indices, for example, for light beams passing in the longitudinal and lateral directions. The term “state in which there is a lens effect” refers to a first state in which a lens effect is produced as in the form of cylindrical lenses extending in the first direction.

A description will be given below of the present embodiment assuming that the first and second directions are respectively the X direction (horizontal in the page) and Y direction (orthogonal to the page) shown in FIGS. 1A and 1B. The X and Y directions are orthogonal to each other on the substrate surface.

The first electrode group 16 provided on the first substrate 14 includes, as a plurality of transparent electrodes, a plurality of electrodes 16L, each having a width Lr, arranged in parallel with a gap Sr between every two electrodes 16L. The electrodes 16L, each having the width Lr, extend in the first direction (X direction). Further, the plurality of electrodes 16L are arranged in parallel at intervals corresponding to a pitch p of cylindrical lenses at which a lens effect is produced.

Similarly, the second electrode group 19 provided on the second substrate 17 includes, as a plurality of transparent electrodes, a plurality of electrodes 19S, each having a width Lc, arranged in parallel with a gap Sc between every two electrodes 19S. The electrodes 19S, each having the width Lc, extend in the second direction (Y direction). Further, the plurality of electrodes 19S are arranged in parallel at intervals corresponding to the pitch p of cylindrical lenses at which a lens effect is produced.

### [Structures of the Electrodes of the Liquid Crystal Lens Array Element 10]

FIG. 4 illustrates the structures of the switches provided for the first and second electrode groups 16 and 19.

One end of each of the electrodes 16L making up the first electrode group 16 is connected to an X line generation section 31 via a switch 33. The X line generation section 31 applies a given voltage to the first electrode group 16. The other end of each of the electrodes 16L is grounded via a switch 34.

One end of each of the electrodes 19S making up the second electrode group 19 is connected to a Y line generation section 32 via a switch 35. The Y line generation section 32 applies a given voltage to the second electrode group 19. The other end of each of the electrodes 19S is grounded via a switch 36.

In the configuration described above, as the X and Y line generation sections 31 and 32 generate given voltages and apply these voltages properly to the switches 33 to 36, an arbitrary area of the liquid crystal lens array element 10 is set to three-dimensional display mode, and the rest of the same element to two-dimensional display mode.

It should be noted that if the X and Y line generation sections 31 and 32 do not generate given voltages, that is, the same sections 31 and 32 do not supply power to the liquid crystal lens array element 10, the entire area of the same element 10 can be set to two-dimensional display mode.

It is likely, in consideration of the manner in which the electronic device 1 is used, that the condition in which the entire area of the liquid crystal lens array element 10 is set to two-dimensional display mode accounts for the largest percentage of the time of use. This provides reduced power consumption as compared to constant supply of power to the liquid crystal lens array element 10.

### [Manufacture of the Liquid Crystal Lens Array Element 10]

In order to manufacture the liquid crystal lens array element 10, a transparent conductive film such as ITO (Indium Tin Oxide) film, for example, is formed in a given pattern on each of the first and second substrates 14 and 17 made of a glass material or other material to form the first and second electrode groups 16 and 19. The orientation films 15 and 18 are formed, for example, by rubbing polyimide or other polymer compound in one direction with a cloth or by oblique deposition of SiO or other film. This makes it possible to orient the major axes of the liquid crystal molecules 13 in one direction.

A sealing material including spacers 12 made of a glass or resin material in a dispersed manner is printed on the orientation films 15 and 18 to maintain the gap d between the first and second substrates 14 and 17 constant. Next, the first and second substrates 14 and 17 are affixed to each other, after which the sealing material including the spacers is hardened. Next, a given liquid crystal material is injected between the first and second substrates 14 and 17 from an opening in the sealing material, after which the opening in the sealing material is sealed. Then, the liquid crystal composition is heated to the isotropic phase and then allowed to gradually cool, thus completing the liquid crystal lens array element 10.

It should be noted that, in the liquid crystal lens array element 10, the larger a refractive index anisotropy Δn of the liquid crystal molecules 13, the larger the lens effect. Therefore, it is preferred that the liquid crystal material should have such a composition. On the other hand, if the liquid crystal composition has the large refractive index anisotropy Δn, the physical properties of the liquid crystal composition are instead impaired, thus resulting in increased viscosity. This may make it difficult to inject the liquid crystal material between the substrates, result in the liquid crystal material in a near-crystalline state at low temperatures, or lead to increased internal electric field, thus requiring a higher voltage to drive the liquid crystal elements. Therefore, it is preferred that the composition of the liquid crystal material should be determined in consideration of both manufacturability and lens effect. A detailed description will be given below of the specific composition of the liquid crystal material in the examples which will be described later.

### [Configuration Example of the Liquid Crystal Lens Array Element Control Section 40]

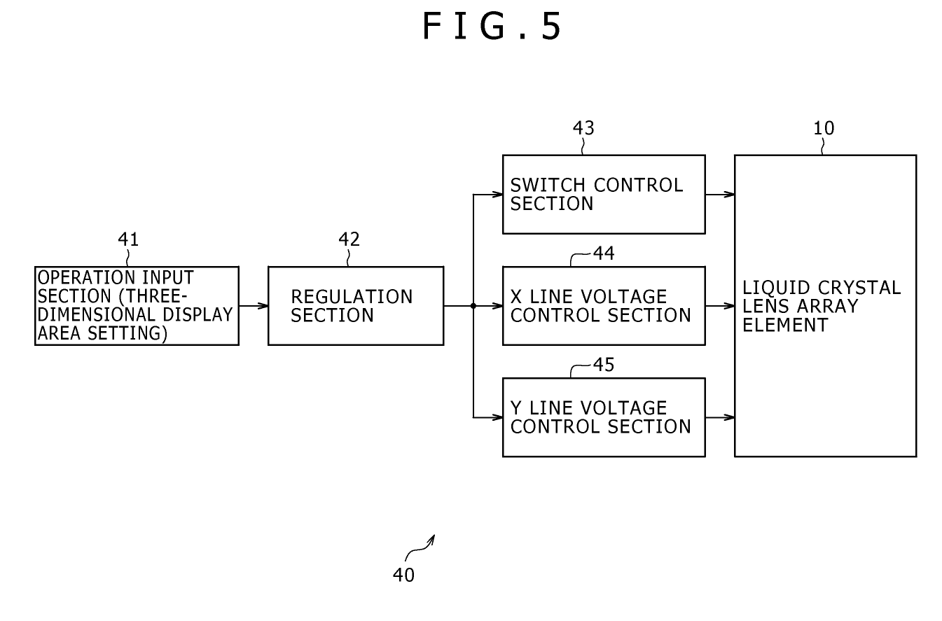

Next, FIG. 5 illustrates a configuration example of a liquid crystal lens array element control section provided in the electronic device 1 to control the liquid crystal lens array element 10.

The liquid crystal lens array element control section 40 includes an operation input section 41, regulation section 42, switch control section 43, X line voltage control section 44 and Y line voltage control section 45.

The operation input section 41 includes a mouse, touch panel or other device to accept the user operation and output the operation signal commensurate with the operation to the regulation section 42.

The regulation section 42 determines the three-dimensional display area in accordance with the operation signal from the operation input section 41. It should be noted that the regulation section 42 can also determine the three-dimensional display area in accordance with control exercised by the application being executed independently of the operation signal based on the user operation. Further, the regulation section 42 controls the switch control section 43, X line voltage control section 44 and Y line voltage control section 45 based on the determined three-dimensional display area.

The switch control section 43 changes the statuses of the switches 33 to 36 connected to the electrodes 16L making up the first electrode group 16 and the electrodes 19S making up the second electrode group 19 in accordance with control exercised by the regulation section 42.

The X line voltage control section 44 controls the X line generation section 31 to generate a given voltage in accordance with control exercised by the regulation section 42. The Y line voltage control section 45 controls the Y line generation section 32 to generate a given voltage in accordance with control exercised by the regulation section 42.

### [Switch Control for the Display Modes]

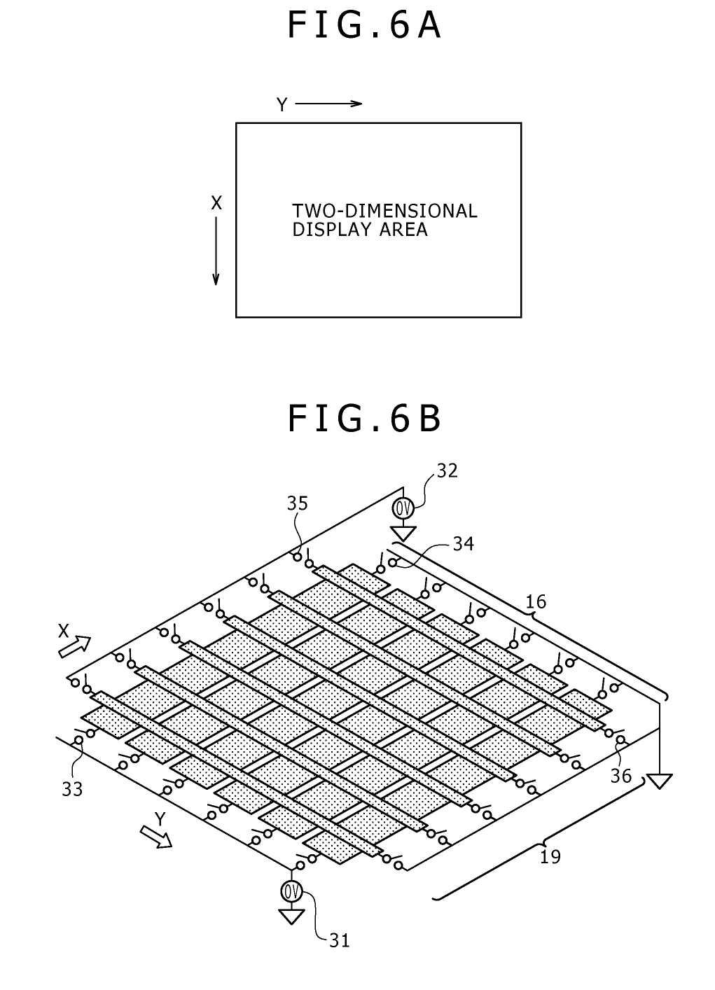

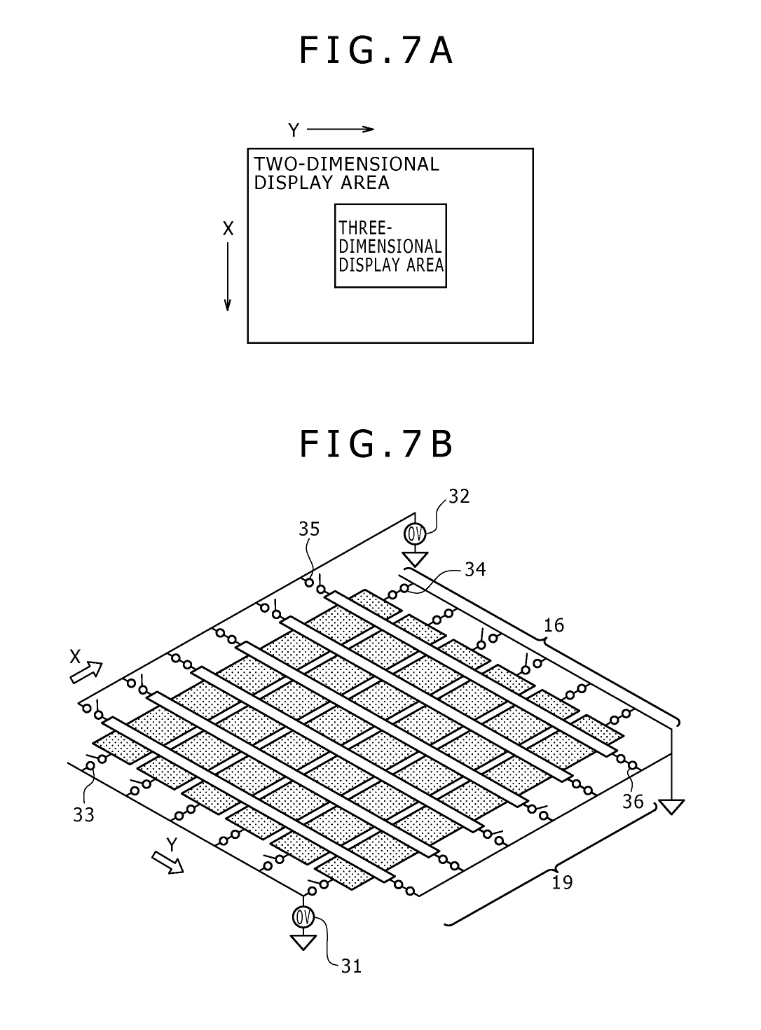

A description will be given next of the statuses of the switches 33 to 36 for the display modes (two-dimensional and three-dimensional display modes) with reference to FIGS. 6A to 7B.

In order to set the entire screen of the display 2 to two-dimensional display mode as illustrated in FIG. 6A, the liquid crystal lens array element 10 is brought into a lens-effect-free state. That is, it is only necessary to switch OFF all the switches 33 to 36 as illustrated in FIG. 6B. Naturally, there is no need for the X and Y line generation sections 31 and 32 to generate any voltages. On the other hand, the switches 34 and 36 on the ground side may be left ON.

In order to provide a three-dimensional display area at an arbitrary position of the screen of the display 2 and use the rest of the screen as a two-dimensional display area as illustrated in FIG. 7A, the statuses of the switches 33 to 36 are changed as illustrated in FIG. 7B, with given voltages generated by the X and Y line generation sections 31 and 32. That is, of the switches 33 on the side of the X line generation section 31 for the first electrode group 16, only those for the three-dimensional display area are switched ON. Of the switches 34 on the ground side, only those for the three-dimensional display area are switched OFF, and the rest switched ON. Further, of the switches 35 on the side of the Y line generation section 32 for the second electrode group 19, only those for the three-dimensional display area are switched ON. Of the switches 36 on the ground side, only those for the three-dimensional display area are switched OFF, and the rest switched ON.

Although not illustrated, if the entire screen of the display 2 is used as a three-dimensional display area, all the switches 33 on the side of the X line generation section 31 for the first electrode group 16 are switched ON, and all the switches 34 on the ground side are switched OFF, with given voltages generated by the X and Y line generation sections 31 and 32. Further, it is only necessary to switch ON all the switches 35 on the side of the Y line generation section 32 for the second electrode group 19 and switch OFF the switches 36 on the ground side.

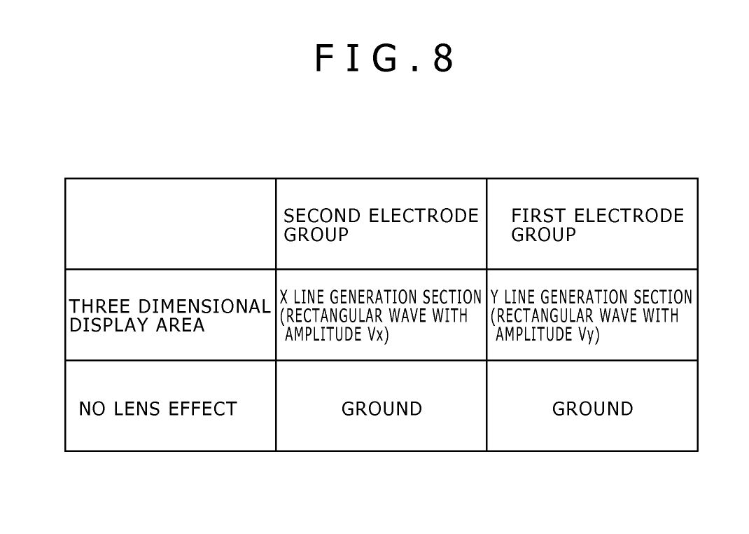

FIG. 8 illustrates the correspondence between the application of voltages to the electrodes in the liquid crystal lens array element 10 and the produced lens effect illustrated in FIGS. 6A to 7B.

As described above, the liquid crystal lens array element 10 according to the present embodiment allows for a three-dimensional display area to be provided at an arbitrary position of the screen of the display 2.

### [Voltages Generated by the X and Y Line Generation Sections 31 and 32]

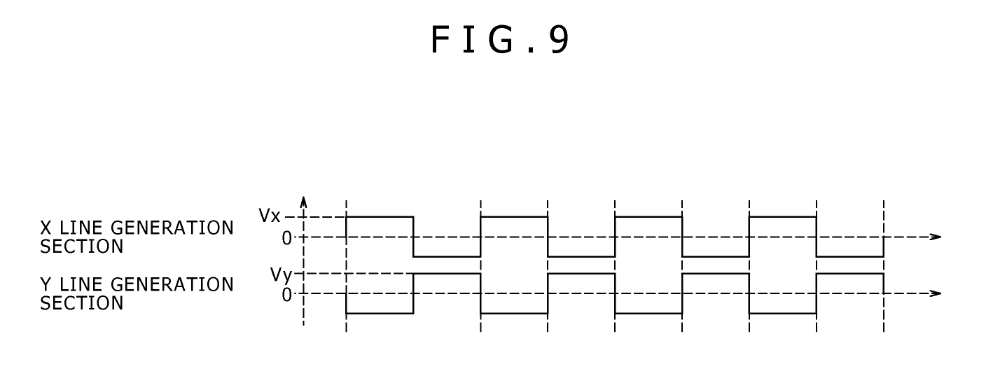

A description will be given next of the voltages generated by the X and Y line generation sections 31 and 32 with reference to FIG. 9.

FIG. 9 illustrates examples of the waveforms of voltages generated by the X and Y line generation sections 31 and 32. As illustrated in FIG. 9, the X line generation section 31 generates a rectangular wave voltage, for example, at a frequency of not less than 30 Hz in the order of +Vx, −Vx, +Vx, −Vx and so on. In contrast, the Y line generation section 32 generates a rectangular wave voltage having the same period in the order of −Vy, +Vy, −Vy, +Vy and so on. That is, the X and Y line generation sections 31 and 32 generate the voltages of almost the same amplitude (Vx=Vy) but out of phase by 180 degrees.

In order to use an arbitrary position of the screen as a three-dimensional display area, a potential difference is generated between the upper and lower transparent electrodes sandwiching the liquid crystal layer 11 so that the alignment of the liquid crystal molecules 13 changes.

More specifically, of the switches 33 on the side of the X line generation section 31 for the electrodes 16L making up the first electrode group 16, only those for the three-dimensional display area are switched ON so that a common voltage (amplitude Vx) is applied. Further, of the switches 35 on the side of the Y line generation section 32 for the electrodes 19S making up the second electrode group 19, only those for the three-dimensional display area are switched ON so that a common voltage (amplitude Vy) is applied. Still further, the switches 34 and 36 are all switched OFF.

Assuming here that the X and Y line generation sections 31 and 32 generate the voltages as shown in FIG. 9, a rectangular wave having an amplitude voltage (Vx+Vy) is applied between the electrodes 19S of the second electrode group 19 and the first electrode group 16. On the other hand, a rectangular wave having an amplitude voltage Vx=Vy=(Vx+Vy)/2 is applied between the portion with no electrodes 19S of the second electrode group 19 and the first electrode group 16. At this time, no motion of the liquid crystal molecules 13 takes place in the portion for the electrodes 19S if the amplitude voltage is equal to or less than the threshold voltage of the liquid crystal. However, the lateral electric field generated by the second electrodes 19S can bring about an initial orientation distribution, i.e., a refractive index distribution, of the liquid crystal molecules 13.

It should be noted that, in order to bring the liquid crystal layer 11 as a whole into a lens-effect-free state, it is only necessary to ensure that the plurality of electrodes making up the first electrode group 16 and the plurality of electrodes making up the second electrode group 19 are all at the same potential (0 V). That is, the X and Y line generation sections 31 and 32 do not generate any voltages, and the electrodes are grounded as illustrated in FIG. 4. In this case, the liquid crystal molecules 13 are aligned uniformly in the direction defined by the orientation films 15 and 18, thus producing a lens-effect-free state.

### EXAMPLES

A description will be given next of specific examples of the electronic device 1 which is the present embodiment.

As for the liquid crystal lens array element 10, the first and second electrode groups 16 and 19 made of ITO are formed by the known photolithography and wet or dry etching techniques between the first and second substrates 14 and 17 made, for example, of a glass material as described above. Polyimide is spin-coated on the electrodes and burned, thus forming the orientation films 15 and 18.

After the firing of the material, the surfaces of the orientation films 15 and 18 are rubbed, followed by cleaning with IPA or other solvent and heating and drying. After cooling, the first and second substrates 14 and 17 are affixed to each other with a gap of 30 to 50 μm provided therebetween in such a manner that the rubbing directions are opposed to each other. This gap is maintained by dispersing the spacers over the entire surface. Then, the liquid material is injected by vacuum injection from the opening in the sealing material, after which the opening is sealed. Then, the liquid crystal material is heated to the isotropic phase and then allowed to gradually cool.

MBBA (p-methoxybenzylidene-p7-butylaniline), a typical nematic liquid crystal, is used in the liquid crystal layer 11. It should be noted that the refractive index anisotropy Δn is 0.255 at 20° C.

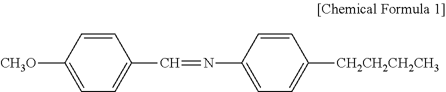

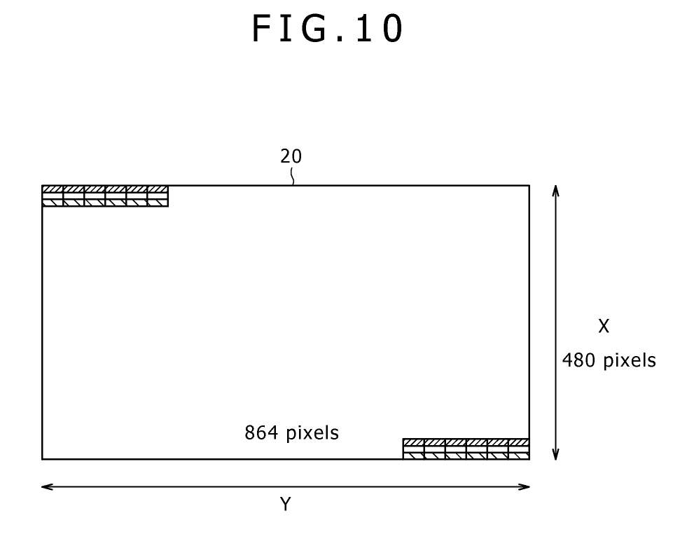

As for the display panel 20, a TFT-LCD panel with a pixel size of 70.5 μm was used. This display panel 20 has red, green and blue pixels arranged in a matrix form as illustrated in FIG. 10. Further, the pixel count of the display panel 20 is N (where N is not less than two) for the pitch p of the cylindrical lenses. In the area set to three-dimensional display mode, as many light beams (lines of sight) as N are provided. Further, a three-inch WVGA (864 by 480 pixels) panel was used as the display panel 20.

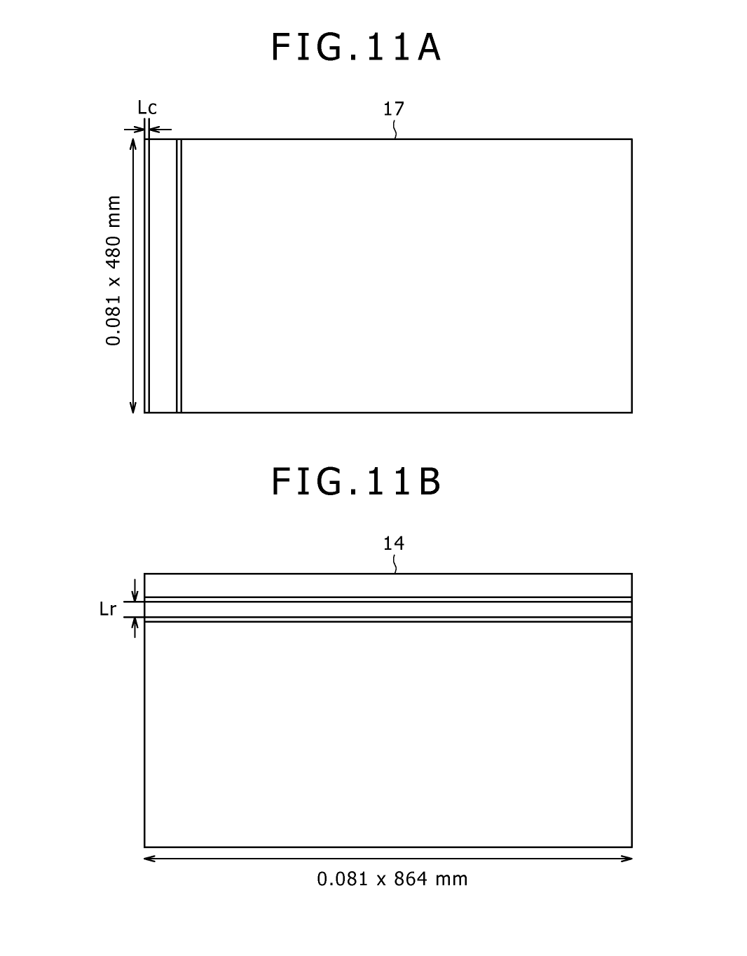

FIGS. 11A and 11B illustrate the electrode structure of the liquid crystal lens array element 10 for the first to third examples which will be described later. FIG. 11A illustrates the electrode structure on the second substrate 17, and FIG. 11B illustrates the electrode structure on the first substrate 14. As illustrated in FIGS. 11A and 11B, the electrodes on the first substrate 14 and those on the second substrate 17 are formed to be orthogonal to each other.

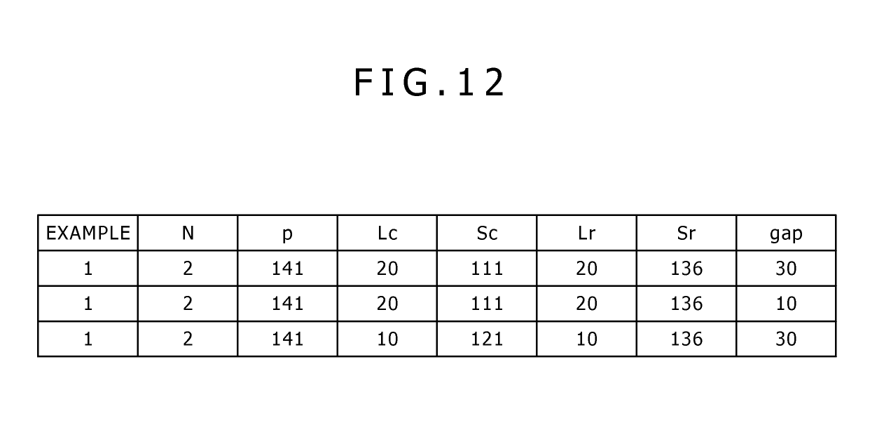

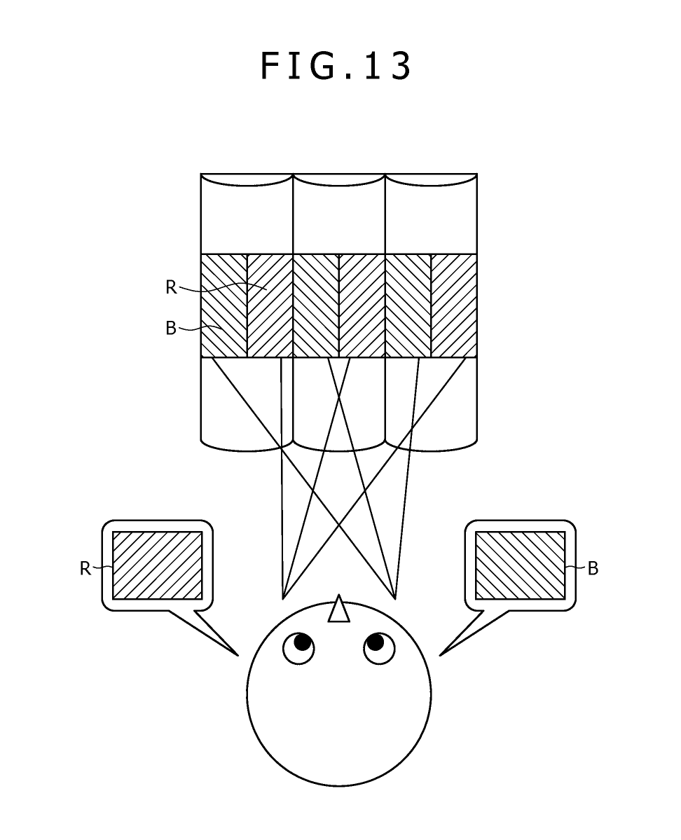

FIG. 12 illustrates various design parameter values in the first to third examples. Character N is the pixel count for the lens pitch p of the display panel 20. Character Lc is the width of each of the electrodes 19S making up the second electrode group 19. Character Sc is the gap between the electrodes 19S. Character Lr is the width of each of the electrodes 16L making up the first electrode group 16. Character Sr is the gap between the electrodes 16L. These values are given in μm units.

It should be noted that power in the form of a rectangular wave at a frequency of not less than 30 Hz is supplied from the X and Y line generation sections 31 and 32. The amplitude voltage of the power is about 5 to 10 V and adjusted according to the lens pitch p and gap d. Normally, the larger the gap d, the higher the amplitude voltage should be.

A description will be given next of the evaluation of the first to third examples. It should be noted that clear criteria for assessing the quality of three-dimensional display have yet to become common to date. Here, therefore, whether or not three-dimensional display can be recognized as such by a simple approach described below is used as an assessment criterion.

FIG. 13 illustrates the concept of evaluating how three-dimensional display appears in the first to third examples. As illustrated in FIG. 13, one blue and one red pixels, or two pixels, are associated with one cylindrical lens of the liquid crystal lens array element 10. As illustrated in FIG. 13, a display pattern is output and displayed on the display panel 20 so that the right and left eyes see blue and red, respectively. Then, the pattern was imaged by cameras arranged at the positions corresponding to the left and right eyes. Whether or not red and blue can be seen separately was used as an assessment criterion. It should be noted that a mixture of red and blue, or purple, is seen in the area set to two-dimensional display mode.

A drive amplitude voltage is increased gradually, and the voltage level immediately before the saturation where increasing the voltage hardly changes the visibility is used as the drive voltage. It should be noted that the voltage amplitude in the form of a rectangular wave V was 2Vx=2Vy. It should also be noted that the time for transition from three-dimensional display mode to two-dimensional display mode (two-dimensional switching response time) as a result of application of 0 V was also observed for evaluation.

The evaluation results are as follows in three different conditions of use for the first to third examples.

### Condition of Use 1 (the Entire Screen Used as a Two-Dimensional Display Area)

In all of the first to third examples, the entire screen turns purple as an evaluation of visual sensation. Two-dimensional display almost similar to that without the liquid crystal lens array element 10 on the display panel 20 can be confirmed.

### Condition of Use 2 (the Entire Screen Used as a Three-Dimensional Display Area)

In all of the first to third examples, red can be observed at the left eye's position, and blue at the right eye's position. That is, it can be confirmed that three-dimensional display mode is achieved by the liquid crystal lens array element 10.

### Condition of Use 3 (a Given Area (300 by 225 Pixels) Used as a Three-Dimensional Display Area, and the Rest as a Two-Dimensional Display Area)

In all of the first to third examples, the entire two-dimensional display area is visually perceived as purple. Therefore, two-dimensional display almost similar to that without the liquid crystal lens array element 10 on the display panel 20 can be confirmed. Further, in the three-dimensional display area, red can be observed at the left eye's position, and blue at the right eye's position. That is, it can be confirmed that three-dimensional display mode is achieved by the liquid crystal lens array element 10.

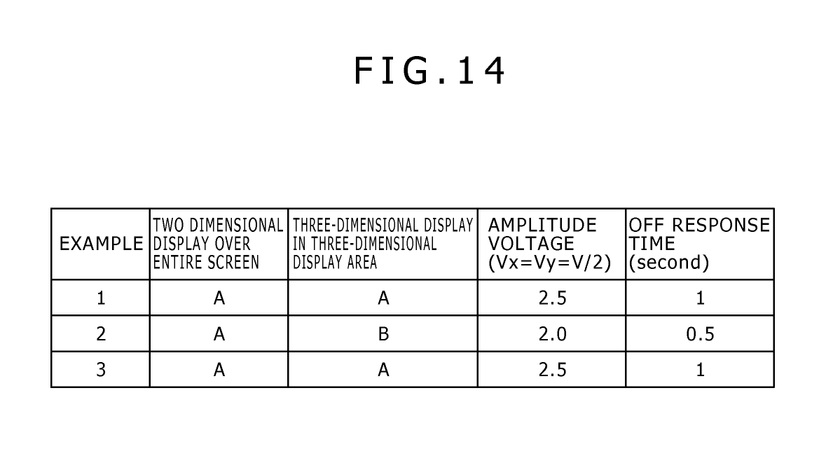

FIG. 14 summarizes the evaluation in each of the conditions of use 1 to 3 described above. In FIG. 14, two-dimensional and three-dimensional display is evaluated on a scale of four levels, i.e., evaluation A representing “excellent,” evaluation B representing “good,” evaluation C representing “fair” and evaluation D representing “bad.”Evaluation A means that red and blue could be sufficiently separately observed. Evaluation C means that red and blue could be marginally separately observed. Evaluation B means that red and blue appeared in a manner intermediate between evaluation A and evaluation C.

As described above, it is clear that, in all the examples, excellent three-dimensional display is achieved in the three-dimensional display area provided at an arbitrary position on the screen.

It should be noted that although only one three-dimensional display area is provided on the screen in the above description, it is possible to provide three-dimensional display areas at a plurality of different positions on the screen.

Further, embodiments of the present invention are not limited to that described above. Embodiments may be modified in various ways without departing from the spirit and scope of the present invention.

The present disclosure contains subject matter related to that disclosed in Japanese Priority Patent Application JP 2010-138520 filed in the Japan Patent Office on Jun. 17, 2010, the entire content of which is hereby incorporated by reference.

What is claimed is:

1. A lens array element, comprising:
first and second substrates arranged to be opposed to each other with a gap therebetween;
a first electrode group, formed on the side of the first substrate opposed to the second substrate, including a plurality of electrodes that extend in a first direction and that are arranged in parallel in the direction along the width thereof;
a first switch group operable to connect a first voltage generation section and the electrodes of the first electrode group, the first voltage generation section adapted to apply voltage to the first electrode group;
a second electrode group, formed on the side of the second substrate opposed to the first substrate, including a plurality of electrodes that extend in a second direction different from the first direction and that are arranged in parallel in the direction along the width thereof;
a second switch group operable to connect a second voltage generation section and the electrodes of the second electrode group, the second voltage generation section adapted to apply voltage to the second electrode group; and
a liquid crystal layer, provided between the first and second substrates, that includes liquid crystal molecules having refractive index anisotropy and that produces a lens effect as a result of change in the direction of alignment of the liquid crystal molecules according to the voltages applied to the first and second electrode groups, wherein
the lens effect of an arbitrary area of the liquid crystal layer changes with change in the statuses of the first and second switch groups.

2. The lens array element of claim 1, wherein
by changing the statuses of the first and second switch groups, an arbitrary area of the liquid crystal layer can be switched to one of two states, one in which there is no lens effect and another in which a lens effect is produced as in the form of cylindrical lenses extending in the first direction, according to the conditions of the voltages applied to the first and second electrode groups.

3. The lens array element of claim 2, wherein
a lens-effect-free state is assumed when the plurality of electrodes making up the first electrode group and those making up the second electrode group are at the same potential, and
a lens effect is produced when a drive voltage is selectively applied to the electrodes at the position corresponding to the pitch of the cylindrical lenses of all the electrodes making up the first electrode group and when a drive voltage is selectively applied to the electrodes at the position corresponding to the pitch of the cylindrical lenses of all the electrodes making up the second electrode group.

4. The lens array element of claim 1, wherein
the first electrode group includes a plurality of first electrodes each having a first width that extend in the first direction and that are arranged in parallel, and
the second electrode group includes a plurality of second electrodes each having a second width smaller than the first width that extend in the second direction and that are arranged in parallel.

5. The lens array element of claim 1, wherein
the first and second voltage generation sections apply rectangular wave voltages that are 180 degrees out of phase with each other.

6. The lens array element of claim 5, wherein
the first and second voltage generation sections apply rectangular wave voltages having the same voltage amplitude.

7. A lens array element, comprising:
first and second substrates arranged to be opposed to each other with a gap therebetween;
a first electrode group formed on the side of the first substrate opposed to the second substrate and extending in a first direction;
a first switch group operable to connect a first voltage generation section and the first electrode group;
a plurality of second electrode groups formed on the side of the second substrate opposed to the first substrate and extending in a second direction different from the first direction;
a second switch group operable to connect a second voltage generation section and the second electrode groups; and
a liquid crystal layer provided between the first and second substrates, wherein
the lens effect of an arbitrary area of the liquid crystal layer changes with change in the statuses of the first and second switch groups.

8. The lens array element of claim 7, wherein
the first and second voltage generation sections apply rectangular wave voltages that are out of phase with each other.

9. The lens array element of claim 8, wherein
the first and second voltage generation sections apply rectangular wave voltages having the same voltage amplitude.

10. An image display device, comprising:
a display section operable to display an image;
a lens array element provided to be opposed to the display surface of the display section and operable to selectively change the passage of light beams from the display section;
determination means operable to determine the position of a three-dimensional display area provided on the screen; and
switch control means operable to control switches, wherein
the lens array element includes
first and second substrates arranged to be opposed to each other with a gap therebetween,
a first electrode group, formed on the side of the first substrate opposed to the second substrate, including a plurality of electrodes that extend in a first direction and that are arranged in parallel in the direction along the width thereof,
a first switch group operable to connect a first voltage generation section and the electrodes of the first electrode group, the first voltage generation section adapted to apply voltage to the first electrode group,
a second electrode group, formed on the side of the second substrate opposed to the first substrate, including a plurality of electrodes that extend in a second direction different from the first direction and that are arranged in parallel in the direction along the width thereof,
a second switch group operable to connect a second voltage generation section and the electrodes of the second electrode group, the second voltage generation section adapted to apply voltage to the second electrode group, and
a liquid crystal layer, provided between the first and second substrates, that includes liquid crystal molecules having refractive index anisotropy and that produces a lens effect as a result of change in the direction of alignment of the liquid crystal molecules according to the voltages applied to the first and second electrode groups,
the switch control means changing the statuses of the first and second switch groups based on the determined position of the three-dimensional display area, thus changing the lens effect of an arbitrary area of the liquid crystal layer.

11. An image display device, comprising:
a display section;
a lens array element;
determination means operable to determine the position of a three-dimensional display area; and
switch control means operable to control switches, wherein
the lens array element includes
first and second substrates arranged to be opposed to each other with a gap therebetween,
a first electrode group formed on the side of the first substrate opposed to the second substrate and extending in a first direction,
a first switch group operable to connect a first voltage generation section and the first electrode group,
a plurality of second electrode groups formed on the side of the second substrate opposed to the first substrate and extending in a second direction different from the first direction,
a second switch group operable to connect a second voltage generation section and the second electrode groups, and
a liquid crystal layer provided between the first and second substrates,
the switch control means changing the statuses of the first and second switch groups based on the determined position of the three-dimensional display area.
